(19) United States
(12) Patent Application Publication
(10) Pub. No.: US 2017/0038308 A1
(43) Pub. Date: Feb. 9, 2017

(54) APPARATUS AND METHOD FOR INSPECTING CONTAINERS

(71) Applicant: KRONES AG, Neutraubling (DE)

(72) Inventor: Jochen Krueger, Hagelstadt (DE)

(21) Appl. No.: 15/121,710

(22) PCT Filed: Jan. 22, 2015
(86) PCT No.: PCT/EP2015/051229

§ 371 Date: Aug. 25, 2016

(30) Foreign Application Priority Data
Feb. 26, 2014 (DE) 102014102543.1

(51) Int. Cl. G01N 21/90; G01N 21/94; G01B 9/02

(52) U.S. Cl. CPC G01N 21/9018; G01B 9/02091; G01B 9/02044; G01N 21/94

(57) ABSTRACT

An apparatus for inspecting containers in a container treatment machine includes an optical probe, for detecting surface irregularities. The probe is formed as an optical coherence tomography probe providing in-plane resolution and/or volume resolution.

The invention relates to an apparatus and a method for inspecting containers with the features of the generic terms of the Claims 1 and/or 11.

Usually, containers are manufactured, sorted, filled, sealed and/or packaged in container treatment machines. In addition, it is possible that reusable containers are sorted with container treatment machines prior to return to the beverage manufacturers. To ensure the quality of the container and/or the product filled in said containers, the containers are inspected with inspection apparatuses before, during and/or after the individual treatment steps.

Thereby, optical measurement and monitoring methods are used inter alia, in which the containers are absorbed with a variety of lighting devices, mirror cabinets, cameras and the like. The camera images obtained this way are then evaluated by means of an image-processing device in order to identify for example foreign matter in the containers. In such methods, it can occur that the camera images have an insufficient contrast in case of colored containers and that the foreign objects are not detected reliably.

Furthermore, x-ray methods have been used in the attempt to detect the foreign objects in the containers. Thereby it has become evident that for example glass shards are difficult to detect by means of x-rays as they have a similar material density as the glass bottle itself Furthermore, certain foreign objects such as flies have a relatively low density and absorb the x-rays only very weakly. Consequently, it may also occur in this context that the foreign objects are not detected reliably.

Furthermore, it is known with regard to cleaning of empty containers that said containers are treated according to the highest conceivable degree of contamination because the contaminations cannot be detected reliably enough.

In addition, it is known that different beverage manufacturers often have similar containers that only differ from one another due to an embossing on the container. As such an embossing is difficult to detect, it may occur that the container is not assigned to the correct beverage manufacturer during sorting.

Therefore, the problem to be solved by the present invention is to provide an apparatus and a method for inspecting containers that enable a reliable detection of foreign objects, contaminations and/or relief-like surface markings (for example embossings) on or in containers.

In an apparatus for inspecting containers with the features of the generic term of Claim 1, this problem is solved with the features of the distinguishing part according to which the optical probe for detecting surface irregularities is designed as an optical coherence tomography probe providing in-plane resolution and/or volume resolution.

The optical coherence tomography in principle is already known from the specifications of EP 1 887 312 A1 and WO 2009/124969 and is used primarily in the clinical field such as in dermatology or ophthalmology. It is for example used to examine the upper skin layer and/or the ocular fundus in microscopic size ranges. Coherence tomography is alternatively also referred to as white-light interferometry.

Furthermore, an optical coherence tomography system with multiple optical probes in known from the DE 10 2011 055735 A1, in which the thickness of a container is recorded on individual measurement points.

Surprisingly, it has now become clear that an optical coherence tomography probe providing in-plane resolution and/or volume resolution detects surface irregularities on containers in a particularly reliable way. Optical coherence tomography is comparable with the ultrasound imaging technology, wherein the sample is screened with light instead of the ultrasound waves. Thereby, the light is partially irradiated back on each material border and/or on each material transition, regardless of the material of the surface irregularity and the light wave length used. Then, the depth of dispersion is evaluated by means of the optical coherence tomography probe out of the light that is irradiated back. Due to the probe being designed with in-plane resolution and/or volume resolution, both the place as well as the form of the surface irregularity can be determined. Consequently, surface irregularities such as foreign objects, contaminations and/or relief-like surface markings can be detected particularly reliably with the apparatus.

The apparatus for inspecting containers can be arranged in a beverage processing station. The container treatment station can be a container manufacturing apparatus (for example a stretch-blowing machine), a rinser, a sorting machine, an empty bottle inspection machine, a filler, a sealing machine, a full bottle inspection machine and/or a packaging machine. The apparatus can be arranged downstream of a filling station for filling a product into the containers. The apparatus can also be arranged downstream of a stretch-blowing machine for PET bottles. The apparatus can also be arranged in a sorting apparatus for reusable bottles or as part of a modular monitoring apparatus for filling level inspection or sealing control.

The containers can be provided to be filled with beverages, hygiene articles, pastes, chemical, biological and/or pharmaceutical products. The containers can be plastic bottles, glass bottles, cans and/or tubes. Plastic containers can in particular be PET, PEN, HD-PE or PP containers and/or bottles. Likewise, the containers can be biodegradable containers or bottles whose main components consist of renewable resources such as sugar can, wheat or corn.

The container treatment machine and/or the inspection apparatus can comprise a transporter for conveying of the containers. The transporter can be a conveyor belt or a carousel. The apparatus can comprise container inputs to twist and/or to relocate the containers in relation to the probe.

The probe can comprise an optical system that is optionally an interferometer. The interferometer can be formed as a Michelson interferometer or Mach-Zehnder interferometer. The optical system can comprise lenses, mirrors, adjustment units and/or a beam splitter. The interferometer can be formed to split the light of a light source by means of a beam splitter into an object and a reference path and to subsequently merge it into an interference path via said path or via a further beam splitter. The probe can comprise a photo sensor that is disposed in the interference path of the interferometer. In other words, the interference path can be arranged in the interferometer between the beam splitter and the photo sensor.

The probe can comprise a light source in the spectral range of 600-1700 nm (near infrared), which is optionally a superluminescence diode or light-emitting diode. Due to the light source working in the spectral range of 600-1700 nm, also containers with a low transparency can be screened in the visible light wave range and surface irregularities can be detected particularly well.

The probe can comprise for signal analysis in the time domain an interferometer with an interference and/or object path with an adjustable length. Through the reference and/or object path with an adjustable length, the container can be screened in the depth particularly easily. The interferometer can comprise an adjustable mirror or a prism for modification of the length of the reference and/or object path. The mirror and/or the prism can be relocatable or twistable. Similar to a reflector, the mirror or the prism can be formed with several mirror surfaces. “Signal analysis in the time domain” can mean in this context that the light signal is screened along its direction of propagation.

For signal analysis in the frequency domain, the probe can comprise an interferometer with an optical grid or prism that is arranged in an interference path. Therefore, the depth of scattering can be determined without mechanical adjustment of the object or reference path. Consequently, no precise guidings or engines have to be used for adjustment of the interferometer so that the probe is particularly cost-efficient. “Signal analysis in the frequency domain” can mean that the light in the interference path is broken down into its spectral components by means of the optical grid or prism. The optical grid can have a grid constant that is smaller than the light wave length of the light source. The optical grid can be a reflection or transmission grid. A lens for focusing of the light onto the photo sensor can be arranged in the interference path directly in front of or directly behind the grid.

The probe can comprise a scanner unit for surface and/or volume screening. Due to the volume or the surface of the container being screened with the scanner unit, the optical system and/or the photo sensor can be structured in a particular simple way. The scanner unit can comprise an electric engine, a rotary encoder, a galvanometer, a lens and/or a mirror. The electric engine or the galvanometer can be formed to swivel the lens or the mirror. Likewise, it is possible that the probe for surface and/or volume screening comprises a scanner unit with multiple rotary axes or several scanner units arranged in a row.

The probe can comprise a line or area sensor with a plurality of light-sensitive cells. The sensor can for example be a CMOS or CCD sensor. The line and/or area sensor can be connected to a signal analysis unit. The signal analysis unit can be arranged in a camera together with the line and/or area sensor.

The line and/or area sensor can comprise at least two signal analysis units that work in parallel and that are each connected to a part of the light-sensitive cells. Due to this, the light information measured by the cells can be evaluated particularly fast. The signal analysis units can be integrated on the sensor chip.

The line and/or area sensor can comprise a separate signal analysis unit for each light-sensitive cell. Therefore, the light information of all cells can be evaluated at the same time and thus the containers can be inspected particularly fast. The separate analytical units can be integrated on the sensor chip.

The probe can be connected to a signal analysis unit that is formed for calculation of resolution data in terms of surface and/or volume of the container and/or of the surface irregularities on the basis of sensor signals. Therefore, the signals of the probe can be processed with particular efficiency. The signal analysis unit can be arranged in the probe or separately from the probe. The signal analysis unit can comprise a digital signal processor that is arranged in the probe or in an external computer.

A measurement field of the probe can be aligned to the container floor or the container neck. Through the alignment of the probe to the container floor, the probe can detect foreign objects on the container floor particularly easily with a low scan depth. Alternatively or in addition, a probe can be arranged on the container neck in order to detect foreign matter that swims in the product filled into the container. Thereby, foreign objects such as flies can be detected particularly well and reliably.

Furthermore, the invention provides with Claim 11 a method for inspecting containers in a container treatment machine, wherein the containers are inspected with an optical probe, characterized in that the probe detects surface irregularities by means of an optical coherence tomography method providing in-plane resolution and/or volume resolution.

As the container can be detected both along the container surface as well as in the depth by means of the optical coherence tomography method, surface irregularities can be identified particularly well.

In the method, the containers can be filled with a product and foreign objects on limit surfaces of the product can be detected as surface irregularities. The foreign objects can for example be flies or glass shards. This ensures that the product gets to the consumers without foreign objects. The limit surfaces can comprise the boundary between the product and a gas volume that is arranged on top of the product in the container (this limit surface is usually referred to as “mirror”).

In the method, contaminations on internal container surfaces can be detected as surface irregularities prior to filling of the containers. The contaminations can for example be mold, ash residues from cigarettes, dust and/or product remainders. Contaminated containers can thereby be sorted out prior to filling. It is also possible to inspect the external surfaces of the containers for contaminations.

Likewise, it is also possible to control and/or to choose a cleaning process of the containers as a function of the contaminations. For example, the containers can be subjected to a special chemical cleaning process in case of particularly strong, sticky contaminations. However, if the containers are contaminated with slightly sticky dust, the containers can only be rinsed. Therefore, cleaning of the containers is particularly resource- and energy-efficient.

In the method, relief-like surface markings on the containers can be recorded as surface irregularities with the probe and identified with an evaluation unit. Therefore, the containers can be assigned to a product type and/or a beverage manufacturer with particular reliability. The relief-like surface markings can be engravings and/or raised markings made of the container material. The surface markings can be formed as symbols or as typeface.

The features described before with regard to the Claims 1-10 can be combined individually or in any combination with the features of the Claims 11-15.

Further features and advantages of the invention will be described in the following based on the embodiments displayed in the Figures. The Figures show:

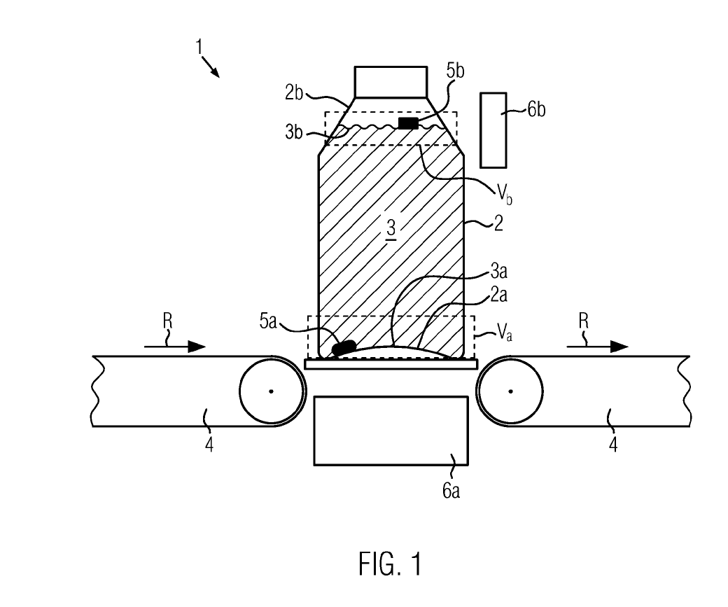

FIG. 1 a display of an embodiment of an apparatus for inspecting recipients in a lateral view;

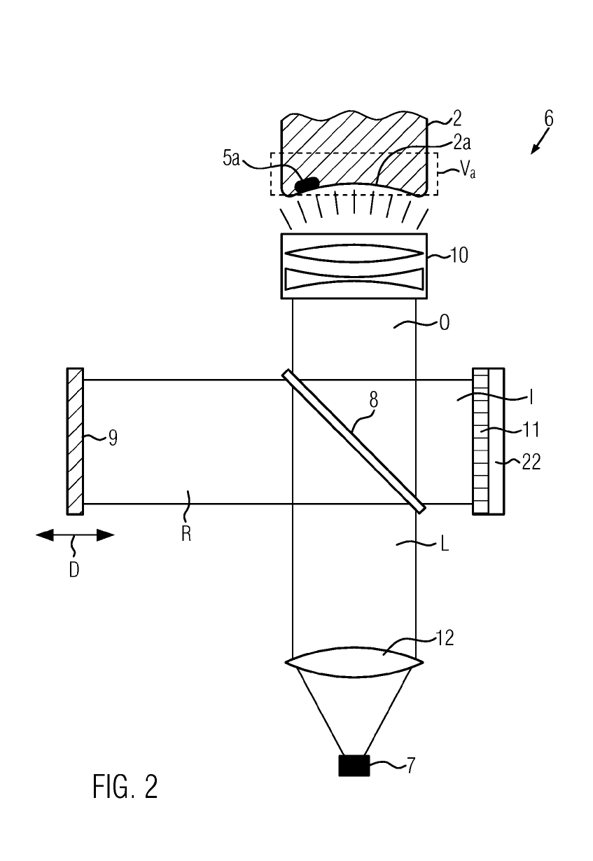

FIG. 2 a display of an optical coherence tomography probe with signal analysis in the time domain in a top view;

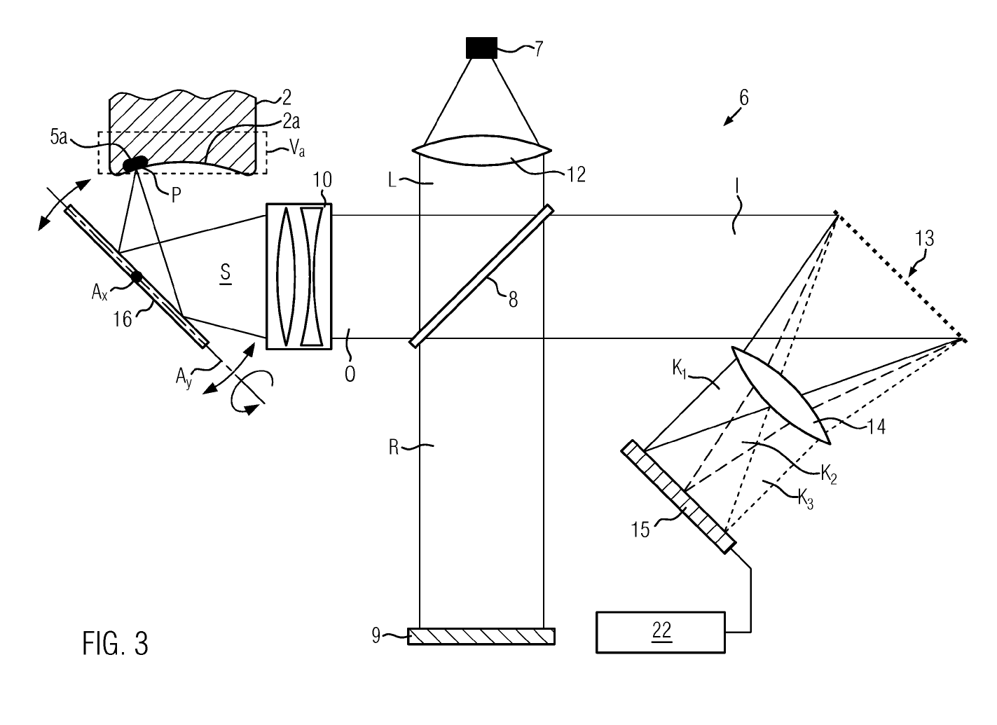

FIG. 3 a display of an optical coherence tomography probe with signal analysis in the frequency domain in a top view;

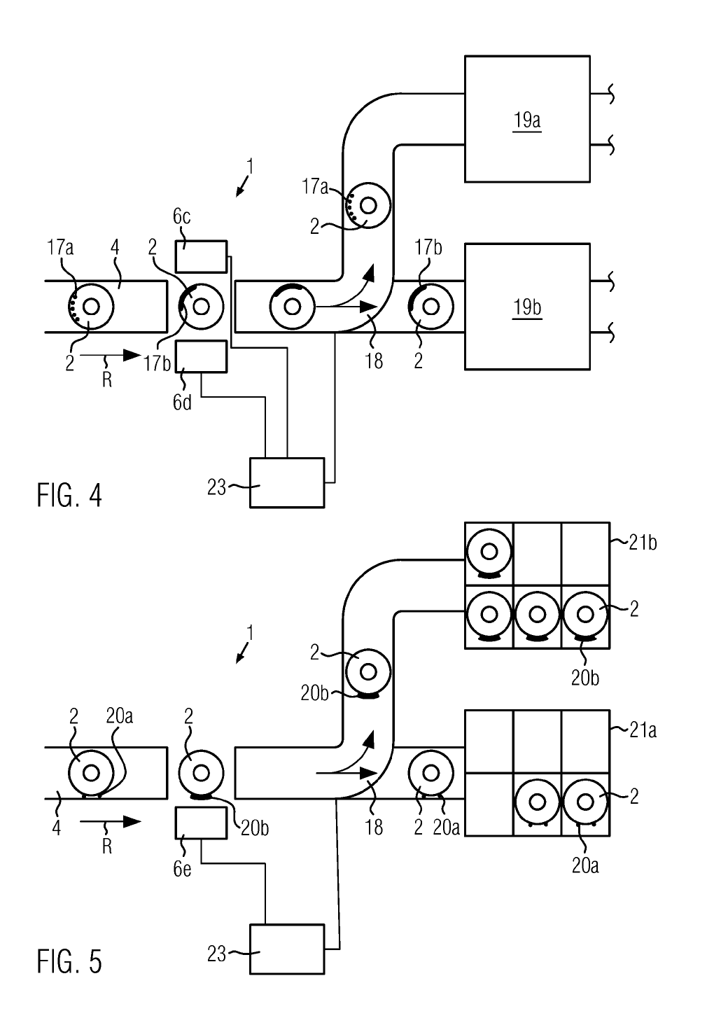

FIG. 4 a display of a further embodiment of an apparatus for inspecting containers in which contaminations are recorded for the control of a cleaning process; and

FIG. 5 a display of a further embodiment of an apparatus for inspecting containers in which relief-like surface markings are identified for sorting of containers.

FIG. 1 shows a lateral view of an embodiment of an apparatus 1 for inspecting containers 2. It shows that the containers 2 are transported by means of a first transporter 4 in the direction R into the inspection apparatus 1. In the inspection apparatus 1, the containers 2 are examined with the optical coherence tomography probes 6a and 6b for foreign objects 5a and 5b. If foreign objects 5a, 5b are eventually found in the container 2, the containers 2 will subsequently be led via the second transporter 4 into a sorting process (not shown herein) in which the contaminated containers 2 are sorted out. If, however, the product 3 is all right, the containers 2 will be led into a packaging unit in which several containers 2 are bundled into a package.

The two probes 6a and 6b are formed herein as optical tomography probes providing volume resolution. The first optical coherence tomography probe 6a thereby has the measurement volume Vₐ. In this measurement volume Vₐ, the container floor 2a, as well as the product 3 that is located on top of it are recorded by volume resolution. If there is a foreign object 5a such as a glass shard on the limit area 3a between the product 3 and the container floor 2a, the light that is irradiated by the optical coherence tomography probe will be reflected back on the foreign object 5a and can be identified with the probe 6a.

Furthermore, it can be seen that the second optical coherence tomography probe 6b records the limit surface 3a between the product 3 and the gas that is located on top of it in the container neck 2b with the measurement volume V_{b}. Here, a foreign object 5b, which can for example be a fly that swims on the liquid surface of the product 3, is shown on the limit surface 3a. The light that is irradiated by the optical coherence tomography probe 6b is reflected back by the foreign object 5b and can be recorded within the measurement volume V_{b}.

It is possible due to the inspection by means of the optical coherence tomography probes 6a and 6b providing volume resolution to reliably detect the foreign objects in the filled container 2 and to sort out faulty containers 2.

It is also possible in this context that the optical coherence tomography probe only provides in-plane resolution, for example in case of an even container floor 2a.

FIG. 2 shows a display of an optical coherence tomography probe providing volume resolution in a top view as it can for example be used in the apparatus 1 from FIG. 1 or in the following embodiments in the FIGS. 4 and 5. It shows that the optical coherence tomography probe 6 is formed as a Michelson-interferometer. Here, other interferometer arrangements such as a Mach-Zehnder-interferometers are also conceivable.

The light source 7 is thereby formed as a superluminescence light-emitting diode that irradiates light in a spectral range of 600-1700 nm. The light of the light source 7 thereby has a particularly short temporal coherence along the light path and a particularly large spatial coherence over the cross-section of the beam. At first, the light of the light source 7 is collimated in the light path L with the lens 12 and led onto the beam splitter 8 that divides it into the object path O and the reference path R. For example, 10% of the light are led into the reference path R and 90% into the object path O in this process. However, other splitting ratios such as 20:80, 30:70, 40:60 or 50:50 are also possible.

The reference path R is designed with a modifiable length for signal analysis in the time domain, wherein the reference mirror 9 is movable along the direction D (for example by means of a linear drive). The light is led from the reference mirror 9 back to the beam splitter 8 and through said beam splitter over the interference path I onto the area sensor 11. In the object path O, the light is led, starting from the beam splitter 8, through a lens 10 onto the container 2. As the light is near infrared light, it can also penetrate colored containers 2 in a good way. The light is then reflected back proportionally on the internal and external surfaces of the container floor 2a as well as on the foreign object 5a and is led back through the lens 10 onto the beam splitter 8 and into the interference path I. There, the light from the object path O and the reference path R interferes on the area sensor 11 that is designed for example as a CMOS sensor. Furthermore, the lens 10 displays the measurement volume Vₐ on the area sensor 11 where it is dissolved laterally by the individual light-sensitive cells.

The interference in the interference path I is particularly strong due to the short temporal coherence of the light source 7 when the optical ways in the reference path R and in the object path O are exactly the same. If, for example the optical way after splitting on the foreign object 5a in the object path O is exactly equal to the corresponding way over the reference path R, the light will interfere on the respective light-sensitive cells of the area sensor 11. To screen different depths in the measurement volume Vₐ, the reference mirror 9 is moved gradually or continuously and the image sequence of the area sensor 11 is evaluated with the signal analysis units 22. The depth of the respective dispersion in the measurement volume Vₐ can be derived from the maximum of the interference signal of each light-sensitive cell of the area sensor 11.

Here, the area sensor 11 has a plurality of light-sensitive cells that are each assigned to a separate signal analysis unit 22. Therefore, the light signal of the individual cells can be evaluated in parallel, and the mirror 9 can be moved particularly fast. Consequently, the measurement volume Vₐ can be screened particularly well. Alternatively it is also possible that there is a smaller number of signal analysis units 22 or exactly a single one that is used to evaluate respectively multiple light-sensitive cells. For example, the signal analysis unit 22 can be arranged as a separate image processing unit in a computer.

FIG. 3 shows a display of an optical coherence tomography probe 6 providing volume resolution that is formed for signal analysis in the frequency domain. Similar to the display in FIG. 2, the probe 6 is designed as a Michelson-interferometer here. However, the interferometer is different due to the reference mirror 9 being fixed and due to the light being broken down into its individual wave length components by the grid 13 for depth resolution in the interference path I.

Also here, the light source 7 is formed as a superluminescence light-emitting diode and irradiates light in a wave length range of 600-1700 nm. After the beam splitter 8, the light proportion of the reference path R is led over the reference mirror 9 and back through the beam splitter 8 into the interference path I. Another proportion of the light is reflected by the beam splitter 8 and arrives in the object path O through the lens 10 and the scanner unit 16 on the container 2. The lens 10 is formed to display the light that is reflected back from the point P onto the line sensor 15 via the grid 13.

Hence, an interference spectrum that contains the whole depth information is recorded. By means of inverse Fourier transformation, the frequency spectrum is then converted into spatial coordinates and we obtain a spatial depth scan that illustrates the position of the foreign object 5a in the depth.

Furthermore, the scanner unit 16 is shown with a mirror that can be swiveled around the axes Aₓ und A_{y}. The light beam S is thereby diverted primarily along the container floor 2a, whereby the measurement volume Vₐ is screened laterally.

With the optical coherence tomography probe 6 providing volume resolution that is shown in FIG. 3, we obtain a volume resolution data record of the overall measurement volume Vₐ from the signal analysis unit 22. Therefore, foreign objects 5a in the container can be detected particularly well.

The optical coherence tomography probes 6 providing volume resolution that are shown in the FIGS. 2 and 3 can in principle be used in any areas of the container 2.

A further embodiment of an apparatus 1 for inspecting containers 2 that is used to detect contaminations 17a, 17b in the container 2 is shown in FIG. 4.

In the installation, the inspection apparatus 1 has for example two optical coherence tomography probes 6c and 6d providing volume resolution, which can respectively be formed according to the FIG. 2 or FIG. 3. They are connected to a central control system 23 that control the switch 18 according to the inspection result.

For example, the containers are reusable containers 2 that are returned by the customer to the beverage manufacturer. They are at first inserted in the apparatus 1 in the transport direction R by means of the transporter 4. There, the containers are inspected with regard to contaminations 17a, 17b by means of the probes 6c and 6d. In case of slightly sticky contaminations 17a such as dust, the containers are inserted into a cleaning device 19a via the switch 18 and rinsed. Due to this process, energy is saved during cleaning on one hand and chemical cleaning agents do not have to be treated or disposed of unnecessarily on the other hand. If, however, particularly strong contaminations 17b such as mold, are detected with the inspection apparatus 1, the container 2 will be inserted in the cleaning device 19b, in which such containers are cleaned particularly reliably with a chemical cleaning agent, by means of the switch 18. This ensures the mold to be removed reliably prior to filling of the product.

FIG. 5 shows an embodiment of an apparatus 1 for inspection of containers 1 in which relief-like surface markings 20a, 20b are identified in order to sort the containers. Also in this case, the inspection device 1 in the apparatus is formed with an optical coherence tomography probe 6e providing volume resolution according to the FIG. 2 or 3.

The apparatus is for example installed at a beverage market. There, reusable containers returned by the customers are placed onto a transporter 4 and inserted in the inspection device 1 in the direction R. The container 2 is screened with the optical coherence tomography probe 6e providing volume resolution and the relief-like surface markings 20a and 20b are recorded. For example, the containers are beer bottles that have different elevations 20a and/or 20b formed as symbols dependent on the manufacturer. They are recorded by the probe 6e and evaluated. As it is possible by means of the optical coherence tomography method to screen the container 2 also in the depth, the elevations 20a and 20b can be recorded with particular reliability.

The measurement data of the probe 6e are transferred to a control system 23 that will then shift the switch 18, dependent on the recorded relief-like surface marking 20a and/or 20b, in a way that the containers 2 are laid into the beer cases 21a and/or 21b in a sorted way according to the respective beer type. Therefore, the only containers with the relief-like surface marking 20a are inserted into the beer cases 21a and only the containers with the relief-like surface marking 20b are inserted in the beer case 21b.

It is possible by means of the optical coherence tomography probe providing volume resolution 6e to detect the relief-like surface markings 20a, 20b with particular reliability and to sort the containers 2.

In the devices 1 described above in relation to the FIG. 1-5, the containers 2 are inspected with probes 6 according to the method described before, whereby the surface irregularities are recorded by means of an optical coherence tomography method providing in-plane resolution and/or volume resolution.

It is clear that features mentioned in the embodiments described before are not limited to these specific combinations and are therefore possible in any other combinations.

1. An apparatus for inspecting containers in a container treatment machine with an optical probe,
wherein
the probe is formed as an optical coherence tomography probe providing in-plane resolution and/or volume resolution for recording of surface irregularities.

2. The apparatus according to claim 1, wherein the probe comprises a light source in the spectral range of 600-1700 nm that is optionally a superluminescence diode or a light-emitting diode.

3. The apparatus according to claim 1, wherein the probe performs signal analysis in the time domain and comprises an interferometer with a reference path and/or object path with a variable length.

4. The apparatus according to claim 1, wherein the probe performs signal analysis in the frequency domain and comprises an interferometer with an optical grid or prism that is arranged in an interference path.

5. The apparatus according to claim 1, wherein the probe performs surface and/or volume screening and comprises a scanner unit.

6. The apparatus according to claim 1, wherein the probe comprises a line or area sensor with a plurality of light-sensitive cells.

7. The apparatus according to claim 6, wherein the line or area sensor comprises at least two signal analysis units that work in parallel and that are each connected to a part of the light-sensitive cells.

8. The apparatus according to claim 6, wherein the line or area sensor comprises a separate signal analysis unit for each light-sensitive cell.

9. The apparatus according to claim 1, wherein the probe is connected to a signal analysis unit that is formed for the calculation of the in-plane and/or volume resolution data of the containers and/or of the surface irregularities on the basis of sensor signals.

10. The apparatus according to claim 1, wherein a measurement field of the probe is aligned to a floor and/or neck of the containers.

11. A method for inspecting containers in a container treatment machine, wherein the containers are inspected with an optical probe,
wherein
the probe records surface irregularities via an optical coherence tomography method providing in-plane resolution and/or volume resolution.

12. The method according claim 11, wherein the containers are filled with a product and wherein foreign objects are recorded as surface irregularities on limit surfaces of the product.

13. The method according to claim 11, wherein contaminations are recorded on internal surfaces of the containers as surface irregularities prior to filling of the containers.

14. The method according to claim 13, wherein a cleaning process of the containers is controlled and/or chosen as a function of the contaminations.

15. The method according to claim 1, wherein relief-like surface markings are recorded as surface irregularities on the containers with the probe and identified with an evaluation unit.
